(19) United States
(12) Patent Application Publication
(10) Pub. No.: US 2006/0179265 A1
(43) Pub. Date: Aug. 10, 2006

(54) Systems and methods for executing x-form instructions

(76) Inventors: Rachel Marie Flood, Austin, TX (US); Bryan Lloyd, Austin, TX (US); Lawrence Joseph Powell JR., Round Rock, TX (US); Michael Thomas Vaden, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/053,529

(22) Filed: Feb. 8, 2005

(51) Int. Cl. G06F 12/04

(52) U.S. Cl. 711/220

(57) ABSTRACT

Systems and methods for executing x-form instructions are disclosed. More particularly, hardware and software are disclosed for detecting an x-form store instruction, determining an address from two address operands of the instruction in one execution unit and receiving the store data of a third operand of the instruction from a second execution unit. Store bypass circuitry transfers store data received from a plurality of execution units to the first execution unit.

### FIELD

The present invention is in the field of digital processing. More particularly, the invention is in the field of executing X-form instructions.

### BACKGROUND

Many different types of computing systems have attained widespread use around the world. These computing systems include personal computers, servers, mainframes and a wide variety of stand-alone and embedded computing devices. Sprawling client-server systems exist, with applications and information spread across many PC networks, mainframes and minicomputers. In a distributed system connected by networks, a user may access many application programs, databases, network systems, operating systems and mainframe applications. Computers provide individuals and businesses with a host of software applications including word processing, spreadsheet, accounting, e-mail, voice over Internet protocol telecommunications, and facsimile.

Users of digital processors such as computers continue to demand greater and greater performance from such systems for handling increasingly complex and difficult tasks. In addition, processing speed has increased much more quickly than that of main memory accesses. As a result, cache memories, or caches, are often used in many such systems to increase performance in a relatively cost-effective manner. Many modern computers also support “multi-tasking” or “multi-threading” in which two or more programs, or threads of programs, are run in alternation in the execution pipeline of the digital processor. Thus, multiple program actions can be processed concurrently using multi-threading.

Modern computers include at least a first level cache L1 and typically a second level cache L2. This dual cache memory system enables storing frequently accessed data and instructions close to the execution units of the processor to minimize the time required to transmit data to and from memory. L1 cache is typically on the same chip as the execution units. L2 cache is external to the processor chip but physically close to it. Ideally, as the time for execution of an instruction nears, instructions and data are moved to the L2 cache from a more distant memory. When the time for executing the instruction is near imminent, the instruction and its data, if any, is advanced to the L1 cache.

As the processor operates in response to a clock, an instruction fetcher accesses data and instructions from the L1 cache. A cache miss occurs if the data or instructions sought are not in the cache when needed. The processor would then seek the data or instructions in the L2 cache. A cache miss may occur at this level as well. The processor would then seek the data or instructions from other memory located further away. Thus, each time a memory reference occurs which is not present within the first level of cache, the processor attempts to obtain that memory reference from a second or higher level of memory. When a data cache miss occurs, the processor suspends execution of the instruction calling for the missing data while awaiting retrieval of the data. While awaiting the data, the processor execution units could be operating on another thread of instructions. In a multi-threading system the processor would switch to another thread and execute its instructions while operation on the first thread is suspended. Thus, thread selection logic is provided to determine which thread is to be next executed by the processor.

A common architecture for high performance, single-chip microprocessors is the reduced instruction set computer (RISC) architecture characterized by a small simplified set of frequently used instructions for rapid execution. Thus, in a RISC architecture, a complex instruction comprises a small set of simple instructions that are executed in steps very rapidly. As semiconductor technology has advanced, the goal of RISC architecture has been to develop processors capable of executing one or more instructions on each clock cycle of the machine. Execution units of modern processors therefore have multiple stages forming an execution pipeline. On each cycle of processor operation, each stage performs a step in the execution of an instruction. Thus, as a processor cycles, an instruction advances through the stages of the pipeline. As it advances it is executed.

In a superscalar architecture, the processor comprises multiple execution units to execute different instructions in parallel. A dispatch unit rapidly distributes a sequence of instructions to different execution units. For example, a load instruction may be dispatched to a load/store unit and a branch instruction may be dispatched to a branch execution unit and both could be executing at the same time. A load instruction causes the load/store unit to load a value from a memory, such as L1 cache, to a register of the processor. A register is physical memory in the core of the processor separate from other memory such as L1 cache. A load instruction comprises a base address, an offset, and a destination address. The offset is added to the base address to determine the location in memory from which to obtain the load data. The destination address is the address of the register that receives the load data.

A store instruction causes the load/store unit to store a value from a register to memory. The instruction comprises an address of a register that contains the data to be stored (the store data.) The instruction also provides a base address and an offset. The offset is read from the instruction itself, so the store instruction calls for two inputs from the registers of the processor: the data to be stored and the base address. Another type of store instruction is the x-form store. The x-form store comprises three fields. Each field is an address. The first two fields provide addresses to two operands that are added together to produce a memory address to store data. The third field provides the address of the data to be stored at the memory address.

A difference between a conventional store instruction and an x-form store instruction is the number of registers that must be read to execute the instruction. An execution unit conventionally receives one or two operands from registers. But an x-form store instruction requires three inputs. Thus, a designer must implement some mechanism for computing an x-form instruction. One mechanism is to provide a third read port to an execution unit. But this is unwieldy and requires considerable dispatch logic. Thus, there is a need for a method to implement the execution of an x-form store instruction that overcomes problems of the prior art.

### SUMMARY

The problems identified above are in large part addressed by systems and methods for executing an x-form instruction. Embodiments implement a method comprising providing two address operands of an instruction to a first execution unit of a digital processor to determine a memory address from the two address operands. A third operand of the instruction passes to a second execution unit which outputs the third operand data as a result. The second execution unit provides this result to the first execution unit. The first execution unit stores the result into memory at the address determined from the two address operands.

One embodiment comprises a first execution unit to determine an address from two address operands of an instruction received by the processor and to store data of a third operand of the instruction in a memory corresponding to the address determined from the two address operands. The embodiment comprises a second execution unit to receive and output the data of the third operand of the instruction an& to pass the data of the third operand to the first execution unit to be stored in the memory corresponding to the address determined from the two address operands.

In one embodiment, a digital processor comprises a mechanism to receive and decode instructions, and a dispatch unit to dispatch received and decoded instructions to a plurality of execution units. A load/store unit receives instructions and determines an address from a first and second operand of an instruction. The load/store unit receives data of a third operand of the instruction from a second execution unit and stores the data of the third operand at the address determined from the first and second operand. An embodiment may further comprise store bypass logic circuitry to control transfers of store data from a plurality of execution units to the load/store unit.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts a digital system within a network; within the digital system is a digital processor.

FIG. 2 depicts a digital processor that executes x-form instructions.

FIG. 3 depicts a functional diagram of an embodiment for processing an x-form store instruction.

FIG. 4 depicts an embodiment for store bypassing for processing an x-form instruction.

FIG. 5 depicts a flow chart for an embodiment to processing an x-form store instruction.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Embodiments include a system for processing x-form instructions comprising a plurality of execution units. A first execution unit receives two address operands of an x-form instruction and adds them to determine a memory address such as an L1 cache address. A third operand of the instruction provides the data to be stored at the determined memory address. The third operand data is read by a second execution unit to execute a a rotate-by-zero instruction. The result of the rotate-by-zero instruction is the third operand data. The first execution unit receives the third operand data from a stage in the pipeline of the second execution unit that is after the rotate-by-zero but before writing the result to a register.

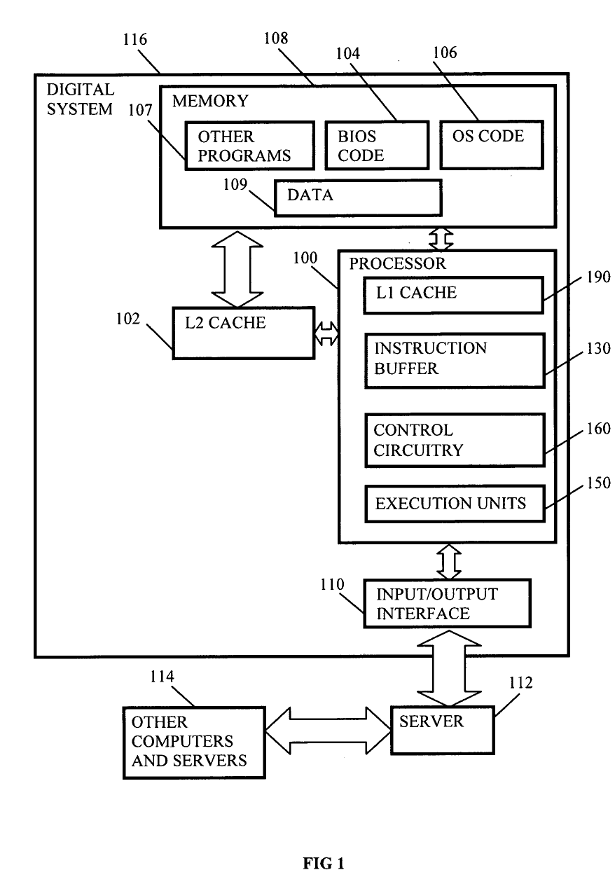

FIG. 1 shows a digital system 116 such as a computer or server implemented according to one embodiment of the present invention. Digital system 116 comprises a processor 100 that can operate according to BIOS Code 104 and Operating System (OS) Code 106. The BIOS and OS code is stored in memory 108. The BIOS code is typically stored on Read-Only Memory (ROM) and the OS code is typically stored on the hard drive of computer system 116. Memory 108 also stores other programs for execution by processor 100 and stores data 109 Digital system 116 comprises a level 2 (L2) cache 102 located physically close to multi-threading processor 100.

Processor 100 comprises an on-chip level one (L1) cache 190, an instruction buffer 130, control circuitry 160, and execution units 150. Level 1 cache 190 receives and stores instructions that are near to time of execution. Instruction buffer 130 forms an instruction queue and enables control over the order of instructions issued to the execution units. Execution units 150 perform the operations called for by the instructions. Execution units 150 may comprise load/store units, integer Arithmetic/Logic Units, floating point Arithmetic/Logic Units, and Graphical Logic Units. Each execution unit comprise stages to perform steps in the execution of the instructions received from instruction buffer 130. Control circuitry 160 controls instruction buffer 130 and execution units 150. Control circuitry 160 also receives information relevant to control decisions from execution units 150. For example, control circuitry 160 is notified in the event of a data cache miss in the execution pipeline.

Digital system 116 also typically includes other components and subsystems not shown, such as: a Trusted Platform Module, memory controllers, random access memory (RAM), peripheral drivers, a system monitor, a keyboard, one or more flexible diskette drives, one or more removable non-volatile media drives such as a fixed disk hard drive, CD and DVD drives, a pointing device such as a mouse, and a network interface adapter, etc. Digital systems 116 may include personal computers, workstations, servers, mainframe computers, notebook or laptop computers, desktop computers, or the like. Processor 100 may also communicate with a server 112 by way of Input/Output Device 110. Server 112 connects system 116 with other computers and servers 114. Thus, digital system 116 may be in a network of computers such as the Internet and/or a local intranet.

In one mode of operation of digital system 116, the L2 cache receives from memory 108 data and instructions expected to be processed in the processor pipeline of processor 100. L2 cache 102 is fast memory located physically close to processor 100 to achieve greater speed. The L2 cache receives from memory 108 the instructions for a plurality of instruction threads. Such instructions may include branch instructions. The L1 cache 190 is located in the processor and contains data and instructions preferably received from L2 cache 102. Ideally, as the time approaches for a program instruction to be executed, the instruction is passed with its data, if any, first to the L2 cache, and then as execution time is near imminent, to the L1 cache.

Execution units 150 execute the instructions received from the L1 cache 190. Execution units 150 may comprise load/store units, integer Arithmetic/Logic Units, floating point Arithmetic/Logic Units, and Graphical Logic Units. Each of the units may be adapted to execute a specific set of instructions. Instructions can be submitted to different execution units for execution in parallel. In one embodiment, two execution units are employed simultaneously to execute a single x-form store instruction. Data processed by execution units 150 are storable in and accessible from integer register files and floating point register files (not shown.) Data stored in these register files can also come from or be transferred to on-board L1 cache 190 or an external cache or memory. The processor can load data from memory, such as L1 cache, to a register of the processor by executing a load instruction. The processor can store data into memory from a register by executing a store instruction.

An instruction can become stalled in its execution for a plurality of reasons. An instruction is stalled if its execution must be suspended or stopped. One cause of a stalled instruction is a cache miss. A cache miss occurs if, at the time for executing a step in the execution of an instruction, the data required for execution is not in the L1 cache. If a cache miss occurs, data can be received into the L1 cache directly from memory 108, bypassing the L2 cache. Accessing data in the event of a cache miss is a relatively slow process. When a cache miss occurs, an instruction cannot continue execution until the missing data is retrieved. While this first instruction is waiting, feeding other instructions to the pipeline for execution is desirable.

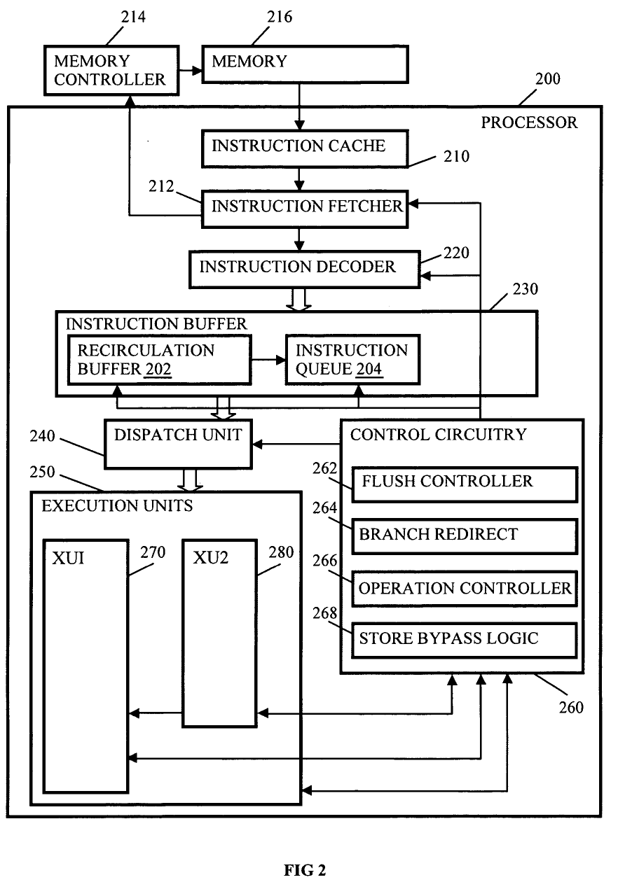

FIG. 2 shows an embodiment of a processor 200 that can be implemented in a digital system such as digital system 116. A level 1 instruction cache 210 receives instructions from memory 216 external to the processor, such as level 2 cache. In one embodiment, as instructions for different threads approach a time of execution, they are transferred from a more distant memory to an L2 cache. As execution time for an instruction draws near it is transferred from the L2 cache to the L1 instruction cache 210.

An instruction fetcher 212 maintains a program counter and fetches instructions from instruction cache 210. The program counter of instruction fetcher 212 comprises an address of a next instruction to be executed. The program counter may normally increment to point to the next sequential instruction to be executed, but in the case of a branch instruction, for example, the program counter can be set to point to a branch destination address to obtain the next instruction. In one embodiment, when a branch instruction is received, instruction fetcher 212 predicts whether the branch is taken. If the prediction is that the branch is taken, then instruction fetcher 212 fetches the instruction from the branch target address. If the prediction is that the branch is not taken, then instruction fetcher 212 fetches the next sequential instruction. In either case, instruction fetcher 212 continues to fetch and send to decode unit 220 instructions along the instruction path taken. After so many cycles, the branch instruction is executed in a branch processing unit of execution units 250 and the correct path is determined. If the wrong branch was predicted, then the pipeline must be flushed of instructions younger than the branch instruction. Preferably, the branch instruction is resolved as early as possible in the pipeline to reduce branch execution latency.

Instruction fetcher 212 also performs pre-fetch operations. Thus, instruction fetcher 212 communicates with a memory controller 214 to initiate a transfer of instructions from a memory 216 to instruction cache 210. Instruction fetcher retrieves instructions passed to instruction cache 210 and passes them to an instruction decoder 220.

Instruction decoder 220 receives and decodes the instructions fetched by instruction fetcher 212. One type of instruction received into instruction decoder 220 comprises an OPcode, a destination address, a first operand address, and a second operand address:

| | | | |
|---|---|---|---|
| OPCODE | First Operand | Second Operand | Destination Address |
| | Address | Address | |

The OPcode is a binary number that indicates the arithmetic, logical, or other operation to be performed by the execution units 250. When an instruction is executed, the processor passes the OPcode to control circuitry that directs the appropriate one of execution units 250 to perform the operation indicated by the OPcode. The first operand address and second operand address locate the first and second operands in a memory data register. The destination address locates where to place the results in the memory data register. Thus, an execution unit will perform the indicated operation on the first and second operand and store the result at the destination address.

In the event of a branch-if-equal-to instruction, however, the destination address is the branch target address, which is selected if the first and second operands are equal. When a branch instruction is resolved, the correct instruction path becomes known. If the two operands are equal, then the correct instruction path begins with the instruction at the branch target address and follows sequentially from there. If the two operands are not equal, the correct instruction path begins with the first instruction following the branch instruction and follows sequentially from there.

A data transfer instruction that copies data from a memory location, such as L1 cache, to a register is traditionally called a load. A typical load instruction comprises an OPCode, a base address, a destination address, and an offset value.

| | | | |
|---|---|---|---|
| OPCODE | Base Address | Destination Address | Offset |

In response to a load instruction, a load/store unit (LSU) of the processor will read the base address, compute the sum of the offset and the base address, read the value of the memory location corresponding to the sum, and write the value to the register corresponding to the destination address.

A data transfer instruction that copies data from a register to a memory location is called a store. A typical store instruction comprises an OPCode, a base address, the address of a register that contains the data to be stored (source address), and an offset value.

| | | | |
|---|---|---|---|
| OPCODE | Base Address | Source Address | Offset |

In response to a store instruction, an LSU of the processor will read the register value to be stored and read the base address, compute the sum of the base address and the offset obtained from the OPCode, and write the register value to the memory location addressed by the sum.

An x-form store instruction is different from a typical store instruction. An x-form store instruction comprises an OPCode, a base address, an address of a register that contains the data to be stored, and an offset value.

| | | | |
|---|---|---|---|
| OPCODE | Base Address | Source Address | Offset Address |

In response to an x-form instruction, the processor must read the offset value, the base address and the store data from registers. The processor then computes the sum of the base address and the offset value to obtain a memory address to write the data. Although the store instruction and the x-form store instruction look similar there is an important difference. To execute the x-form instruction the offset value is an input operand to the load/store unit that must be read from a register. Thus, to execute the x-form instruction requires three operands from the data registers of the processor. To execute the simpler store instruction, the offset value is received from the instruction, rather than from a register.

Instruction buffer 230 receives the decoded instructions from instruction decoder 220. Instruction buffer 230 comprises memory locations for a plurality of instructions. Instruction buffer 230 may reorder the order of execution of instructions received from instruction decoder 220. Instruction buffer 230 thereby provides an instruction queue 204 to provide an order in which instructions are sent to a dispatch unit 240. For example, in a multi-threading processor, instruction buffer 230 may form an instruction queue that is a multiplex of instructions from different threads. Each thread can be selected according to control signals received from control circuitry 260. Thus, if an instruction of one thread becomes stalled in the pipeline, an instruction of a different thread can be placed in the pipeline while the first thread is stalled.

Instruction buffer 230 may also comprise a recirculation buffer mechanism 202 to handle stalled instructions. Recirculation buffer 202 is able to point to instructions in instruction buffer 230 that have already been dispatched and have become stalled. If an instruction is stalled because of, for example, a data cache miss, the instruction can be reintroduced into instruction queue 203 to be re-executed. This is faster than retrieving the instruction from the instruction cache. By the time the instruction again reaches the stage where the data is required, the data may have by then been retrieved. Alternatively, the instruction can be reintroduced into instruction queue 204 only after the needed data is retrieved.

Dispatch unit 240 dispatches the instruction received from instruction buffer 230 to execution units 250. In a superscalar architecture, execution units 250 may comprise load/store units, integer Arithmetic/Logic Units, floating point Arithmetic/Logic Units, and Graphical Logic Units, all operating in parallel. Dispatch unit 240 therefore dispatches instructions to some or all of the executions units to execute the instructions simultaneously. Execution units 250 comprise stages to perform steps in the execution of instructions received from dispatch unit 240. Data processed by execution units 250 are storable in and accessible from integer register files and floating point register files not shown. Data stored in these register files can also come from or be transferred to an on-board data cache or an external cache or memory.

Each stage of each of execution units 250 is capable of performing a step in the execution of a different instruction. In each cycle of operation of processor 200, execution of an instruction progresses to the next stage through the processor pipeline within execution units 250. Those skilled in the art will recognize that the stages of a processor “pipeline” may include other stages and circuitry not shown in FIG. 2. In a multi-threading processor, each stage of an execution unit can process a step in the execution of an instruction of a different thread. Thus, in a first cycle, execution unit stage 1 may perform a first step in the execution of an instruction of a first thread. In a second cycle, next subsequent to the first cycle, execution unit stage 2 may perform a next step in the execution of the instruction of the first thread. During the second cycle, execution unit stage 1 performs a first step in the execution of an instruction of a second thread. And so forth.

FIG. 2 shows a first execution unit (XU1) 270 and a second execution unit (XU2) 280 of a processor with a plurality of execution units. In one embodiment, XU1 270 is adapted to add two operands to determine an, address to store data. XU2 280 is adapted to perform a rotate by zero operation. The output of a rotate-by-zero operation is the input of the operation. When processor 200 receives an x-form store instruction, XU1 270 performs the addition of the two operands of the instruction to determine the address of where in memory to store the data. XU2 280 receives and outputs operand C. Thus, to execute the x-form instruction requires three operands from the data registers of the processor. Two of the operands—the base address and offset value—are input to an execution unit that computes an address to store the data of the third operand. The data of the third operand is the result of the rotate-by-zero operation, which is transferred from XU2 280 to XU1 270. XU1 270 stores the data received from XU2 280 into the memory location corresponding to the address computed by adding the offset value to the base address.

FIG. 2 also shows control circuitry 260. Control circuitry 260 comprises circuitry to perform a variety of functions that control the operation of processor 200. For example, control circuitry 260 may comprise a branch redirect unit 264 to redirect instruction fetcher 212 when a branch is determined to have been mispredicted. Control circuitry may further comprise a flush controller 262 to flush instructions younger than the mispredicted branch instruction. An operation controller 266 interprets the OPCode contained in an instruction and directs the appropriate execution unit to perform the indicated operation. Store bypass logic 268 performs store bypass operations to transfer store data from one or more of execution units 250 to a load/store unit (LSU). Control circuitry 260 may further comprise thread selection circuitry to select among instruction threads to execute.

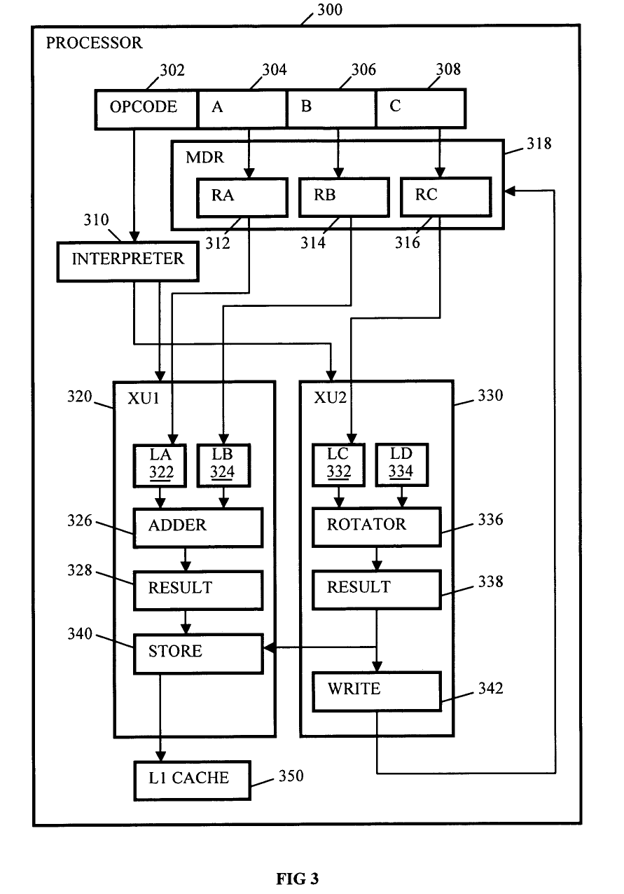

FIG. 3 shows a functional diagram of an embodiment of a processor 300 for x-form store instruction execution. The processor receives an x-form instruction comprising an OPCode 302, a first address A 304, a second address B 306, and a third address C 308. These are addresses of locations in a register file denoted as memory data register (MDR) 318. Address A 304 addresses a memory data register RA 312. Address B 306 addresses a memory data register RB 314. Address C 308 addresses a memory data register RC 316. The operands at each address are passed to execution units 320 and 330 to execute the x-form store instruction.

An instruction interpreter 310 interprets the OPCode and detects when an x-form store instruction occurs. When an x-form store instruction is detected, instruction interpreter 310 instructs a first execution unit XU1 320 to perform an addition of an operand received into a latch LA 322 from memory data register RA 312 and an operand received into a latch LB 324 from memory data register RB 314. These are the address operands of the instruction. Instruction interpreter 310 also instructs a second execution unit XU2 330 to perform a rotate-by-zero on the data operand received into a latch LC 332 from memory data register RC 316. A latch LD 334 is also provided to receive a another operand when other instructions are to be performed by XU2.

An adder 326 in XU1 320 adds the values in latches 322 and 324 to produce a result stored in a result pipe 328. A rotator 336 in XU2 330 rotates the value in latch 332 to produce the value in latch 332 in a result pipe 338. The result is passed to a write unit 342 to write the result to memory data register 318. The result from result pipe 338 is also transferred to XU1 320 to complete the execution of the store 340, and store the data from memory data register RC 316 into the memory location of L1 cache 350 corresponding to the address computed by XU1 320. Thus, a single x-form instruction is executed using two parallel execution units: one that determines the address to store the data, and one that produces the data to be stored.

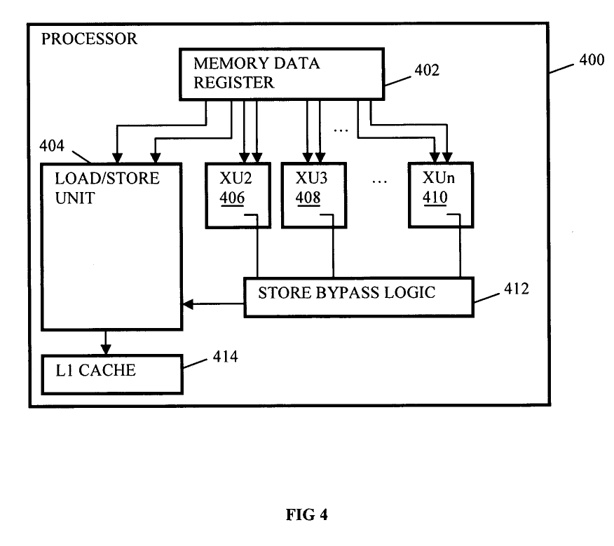

FIG. 4 shows an embodiment for store bypassing in a processor 400 for processing x-form instructions. A load/store unit (LSU) 404 and each of a plurality of execution units XU2 406, XU3 408, . . . XUn 410 can receive two operands from a memory data register 402. When executing an x-form store instruction, LSU 404 will add two operands of the instruction received from memory data register 402 to determine an address to store the result of a rotate-by-zero operation performed on the third operand of the instruction by execution unit XU2 406. LSU 404 obtains the result of the rotate-by-zero operation before the result is written to a register. There are typically a number of stages between the stage that determines the result of an instruction and the stage that writes that result to a memory data register. LSU 404 may thus obtain a result from any of these intervening stages without waiting for the result to be written to the register.

The process of passing the result of the rotate-by-zero operation to LSU 404 may be merged into the store bypassing process involving other execution units XU3 408 through XUn 410. Thus, LSU 404 may obtain the results of other execution units prior to their results being written to the register file. Store bypass logic 412 controls the transfer of results to LSU 404 from the result pipes of other execution units. Store bypassing improves processor performance by providing store data more quickly than waiting for the store data to be written to a register. Store bypassing is justified because of the great number of times storing data from a register into memory is required. Note further that using the store bypass circuitry presently implemented in processors to transfer the store data of the x-form store instruction requires no additional transfer circuitry between the two execution units.

Since instructions are executed in parallel, data dependencies may arise. For example, referring to FIG. 3, the value that execution unit 330 is to read from register RC 316 to execute an x-form store instruction may be computed in a third execution unit according to an older instruction that has not yet completed execution. If execution unit 330 reads the value of RC 316 in response to the x-form store instruction before RC 316 is updated with the correct value provided by the older instruction, the result of the rotate-by-zero operation is incorrect. When this occurs, store bypass logic 412, 268 transfers to LSU 404 the result of executing the older instruction when that result becomes available in the result pipe of the third execution unit. Thus, store bypass logic 412 will overwrite the incorrect value with the correct value received from the third execution unit.

Consider the following instruction sequence:
add G5, G0, G1
add G6, G5, G4
   The first instruction instructs the machine to load the operand registers of an arithmetic/logic unit (ALU) with the contents of registers G0 and G1 and to add them. The result of G0+G1 is stored in a register G5. The second instruction instructs the machine to load the operand registers of the ALU with the contents of registers G5 and G4 and to add them. The result is stored in a register G6. The second instruction calls for the result of the first instruction to be loaded into the operand register of the ALU. Therefore, the two add instructions must be dispatched at least one cycle apart.

In contrast, consider an add followed by an x-form store instruction:
add G5, G0, G1
x-form store G5, G1, G2
   The add instruction calls for the sum of the contents of G0 and G1 to be stored in G5. In the x-form store instruction, the store data is read from register G5 and stored at the address determined by adding the contents of G1 and G2. If G5 is not updated by the add instruction before G5 is read by the x-form store instruction, then the store bypass logic obtains the result of the add instruction from the ALU result pipe and this result will overwrite the un-updated value obtained from G5. Thus, since the store-bypassing is performed post-execution of the add instruction but before the results are written to an input register, the two instructions can be dispatched on the same cycle.

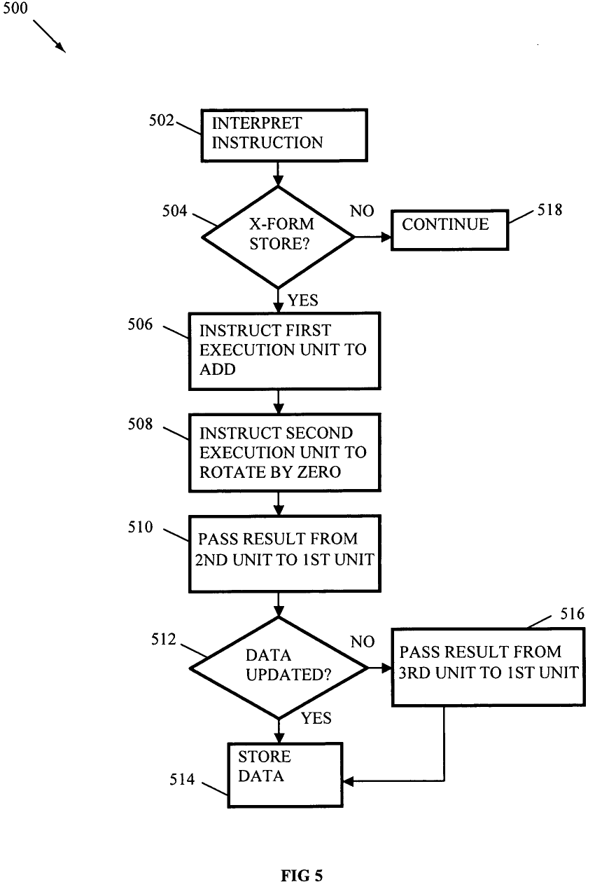

FIG. 5 shows a flow chart of one embodiment for processing an x-form store instruction. A digital processor receives and interprets an instruction (element 502). The processor determines if the instruction is an x-form store instruction (element 504.) If not, processing continues normally (element 518.) If the instruction is an x-form store instruction, the processor instructs a first execution unit to add the two address operands of the instruction (element 506.) The processor also instructs a second execution unit to rotate by zero a third operand of the instruction (element 508.) The result of the rotate-by-zero operation from the second execution unit is passed to the first execution unit (element 510.) The processor determines if this result is data that has been updated by an instruction executed in a third execution unit (element 512.) If not, then the result of the instruction executed in the third execution unit is passed to the first execution unit (element 516) to override the results received from the second execution unit. As a result, the data from the third execution unit is stored (element 514.) If, however, the data from the second execution unit is the data updated by the instruction executed by the third execution unit, then the data from the second execution unit is stored (element 514.)

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for processing an instruction in a digital processor, comprising:
determining a memory address based upon two address operands of the instruction received by a first execution unit of the processor;
sending data of a third operand of the instruction received by a second execution of the processor to the first execution unit; and
storing the data of the third operand into the memory address.

2. The method of claim 1, wherein determining a memory address from the two address operands comprises adding the two address operands.

3. The method of claim 1, further comprising instructing the first execution unit to add the two address operands and instructing the second execution unit to perform a rotate-by-zero operation on the third operand, in response to an x-form store instruction.

4. The method of claim 1, further comprising sending the third operand data to store bypass circuitry that receives store data from a plurality of execution units and distributes the third operand data and store data to the first execution unit to be stored in memory.

5. The method of claim 4, further comprising replacing the third operand data from the second execution unit by data from a third execution unit if the third operand data is not updated by an older instruction.

6. The method of claim 1, further comprising replacing the third operand data from the second execution unit by data from a third execution unit if the third operand data is not updated by an older instruction.

7. A digital processor, comprising
a first execution unit to determine an address from two address operands of an instruction received by the processor and to store data of a third operand of the instruction in a memory corresponding to the address determined from the two address operands; and
a second execution unit to receive and output the data of the third operand to the first execution unit to be stored in the memory corresponding to the address determined from the two address operands.

8. The processor of claim 7, further comprising store bypass circuitry to receive the third operand data from the second execution unit and store data from a plurality of execution units and to distribute the third operand data and store data to the first execution unit to be stored in memory.

9. The processor of claim 7, further comprising store bypass circuitry to control transfer of the third operand data to the first execution unit from the second execution unit and to control transfer of store data from other execution units to the first execution.

10. The processor of claim 9, wherein the store bypass circuitry passes data from a third execution unit to the first execution unit to replace the data of the third operand with the data from the third execution unit.

11. The processor of claim 7, further comprising circuitry to detect an instance of an x-form store instruction and to direct the first execution unit to add the two address operands and to direct the second execution unit to perform a rotate-by-zero operation on the third operand data.

12. The processor of claim 7, further comprising circuitry to replace the data from the second execution unit with data from a third execution unit.

13. A digital system for processing data, comprising:
a mechanism to receive and decode instructions;
a dispatch unit to dispatch received and decoded instructions to a plurality of execution units; and
a load/store unit to determine an address from a first and second operand of an instruction, to receive data of a third operand of the instruction from a second execution unit, and to store the data of the third operand at the address determined from the first and second operand.

14. The system of claim 13, further comprising circuitry to detect an instance of an x-form store instruction and to direct the load/store unit to add the two address operands and to direct the second execution unit to perform a rotate-by-zero operation on the third operand data.

15. The system of claim 13, further comprising store bypass circuitry to control transfer of the third operand data to the first execution unit from the second execution unit and to control transfer of store data to the first execution unit from other execution units.

16. The system of claim 15, wherein the store bypass circuitry comprises circuitry to determine if the data of the third operand of the instruction depends upon the result of an older instruction.

17. The system of claim 15, wherein the store bypass circuitry comprises circuitry to pass data from a third execution unit to the load/store unit to replace the data of the third operand with the data from the third execution unit.

18. The system of claim 13, wherein the mechanism to receive and decode instructions comprises an instruction fetcher adapted to cause instructions to be written to and read from an instruction cache.

19. The system of claim 13, wherein the store bypass circuitry comprises circuitry to determine if the data of the third operand of the instruction depends upon the result of an older instruction.

20. The system of claim 13, wherein the load/store unit is adapted to receive store data from a third execution unit to replace the data of the third operand of the instruction received from the second execution unit.
